(19) United States
(12) Patent Application Publication
(10) Pub. No.: US 2023/0353483 A1
(43) Pub. Date: Nov. 2, 2023

(54) NETWORK CONTROL SYSTEM, PATH COMPUTATION METHOD AND PROGRAM

(71) Applicant: Nippon Telegraph and Telephone Corporation

(72) Inventors: Hiroki MORI, Musashino-shi, Tokyo (JP); Satoshi NAKATSUKASA, Musashino-shi, Tokyo (JP); Ken TAKAHASHI, Musashino-shi, Tokyo (JP)

(21) Appl. No.: 18/022,399

(22) PCT Filed: Aug. 25, 2020
(86) PCT No.: PCT/JP2020/032079

§ 371 Date: Feb. 21, 2023

(51) Int. Cl. H04L 45/12; H04L 45/42; H04L 43/0852; H04L 43/087; H04L 43/0882

(52) U.S. Cl. CPC H04L 45/124; H04L 45/123; H04L 45/42; H04L 43/0858; H04L 43/087; H04L 43/0882

(57) ABSTRACT

The network control system 100 includes an NW state measurement part 111 which measures a network topology, a delay amount of each link, a jitter, a traffic amount, and a link band and makes an NW state holding DB 112 holding them as NW state information, and an NW design information holding DB 132 which holds a quality requirement including an endpoint, a delay amount, and jitter, and information on a necessary band, as a design information of each NW, and a route calculation unit 121 which calculates an optimum route with quality requirements as constraint conditions on the basis of the NW state information held in the NW state holding DB 112 and the NW design information held in the NW design information holding DB 132, and a route control unit 131 on the basis of the route information calculated by the route calculation unit 121.

### TECHNICAL FIELD

The present invention relates to a network control system for setting an appropriate configuration of a network, a route calculation method and program.

### BACKGROUND ART

In a network that require low latency as represented by 5G (herein after, appropriately referred to as “NW”), it is necessary to perform appropriate control and operation according to the delay amount in the NW. For this purpose, it is necessary to measure and grasp the delay state in the NW with high accuracy, and to perform optimum route control based on the information. The delay amount in the NW is measured by deploying measurement devices at both ends of the section to be measured and using the Two-way Active Protocol (TWAMP), a protocol to determine the response time (Round Trip Time, RTT) of an ICMP (International Control Message Protocol) packet such as ping and NW state. Further, a method for transmitting a plurality of packets for delay measurement from a measurement system connected to a measurement target NW and measuring a delay amount and jitter of each link from a combination of the RTT has been proposed (NPL 1 reference).

On the other hand, regarding the route control, a technique for optimizing the resource utilization efficiency of the entire NW is proposed by mainly paying attention to the traffic amount of each flow unit or each link unit.

A technique for efficiently using NW resources by minimizing the maximum link use rate in the NW, that is, controlling the flow so that the flow does not deviate to a specific link is described in the NPL 2.

### CITATION LIST

### Non Patent Literature

[NPL 1] Hiroki Mori, and 4 others, “Proposal of high accuracy delay measurement system,” IEICE Technical Report, NS2019-231 (2020-03), pp. 301-306, March 2020.
[NPL 2] Ryuta Sugiyama, Tomonori Takeda “Study for Route Optimization in a Large IP Network/86> by Centralized Control,” IEICE Technical Report, NS2014-1 (2014-4), pp. 1-4 April 2014.

### SUMMARY OF INVENTION

### Technical Problem

In the methods disclosed in NPL 1 and 2, attention is paid only to the traffic amount, and there is a possibility that congestion of a specific link is eliminated by optimizing the resource utilization efficiency, and as a result, delay is reduced. However, there is a possibility that the delay quality deteriorates by bypassing the long-distance path unintentionally, and it is not guaranteed that an optimum NW satisfying the quality required for the delay is provided.

The present invention has been made in view of such a background, and an object of the present invention is to provide a network control system, a route calculation method, and a program that can achieve both optimization of required quality and resource utilization efficiency.

### Solution to Problem

In order to solve the above problem, the present invention is a network control system for changing a path set in a network (NW), and the network control system is characterized in including: an NW state measurement unit that measures a network topology, a delay amount of each link, the traffic amount, and the link band and causes an NW state holding unit to hold the measured information as NW state information; an NW design information holding unit that holds quality requirements of endpoint including the quantity of delay and information on a required band, as design information of each NW; a route calculation unit that performs an optimum route calculation using the quality requirements as constraints, on the basis of the NW state information held in the NW state holding unit and the NW design information held in the NW design information holding unit; a route control unit that performs route control on the basis of the route calculated by the route calculation unit.

### Advantageous Effects of Invention

According to the present invention, it is possible to provide a network control system, a route calculation method, and a program that can achieve both optimization of required quality and resource utilization efficiency.

### BRIEF DESCRIPTION OF DRAWINGS

FIG. 1 is a diagram illustrating an example of configuration of a network control system according to the embodiment of the present invention.

FIG. 2 is a block diagram showing a configuration of a delay measurement system according to a technology described in NPL 1.

FIG. 3 is a flowchart showing a procedure of the route calculation method of the network control system according to the present embodiment.

FIG. 4 is a flowchart showing optimum route calculation in the case of minimizing the maximum link use rate in the NW of the network control system according to the present embodiment.

FIG. 5 is a flowchart showing optimum route calculation in the case of minimizing the total of delay amounts and jitters of each NW of the network control system according to the present embodiment.

FIG. 6 is a flowchart showing optimum route calculation in the case of minimizing the route change scale of the network control system according to the present embodiment.

FIG. 7 is a diagram explaining operation in the initial state of the network control system according to the present embodiment.

FIG. 8 is a diagram showing an input/output point (endpoint) of VPN information stored in an NW state holding DB of a network control system, and a delay amount, jitter and link use rate of a link between the input/output point (endpoint) according to the present embodiment.

FIG. 9 is a diagram explaining operation of the route calculation of the network control system according to the present embodiment.

FIG. 10 is a diagram explaining update operation of the network control system according to the present embodiment.

FIG. 11 is an image diagram in which an NW state measurement result after route control is reflected on a link between the input/output points (endpoint) of VPN information held in an NW design information holding DB according to the present embodiment.

FIG. 12 is a hardware configuration diagram showing an example of a computer that realizes functions of the route calculation method according to the present embodiment.

### DESCRIPTION OF EMBODIMENTS

Hereinafter, a network system and the like in a mode (herein after, referred to as “the present embodiment”) will be described with reference to the drawings.

### EMBODIMENT

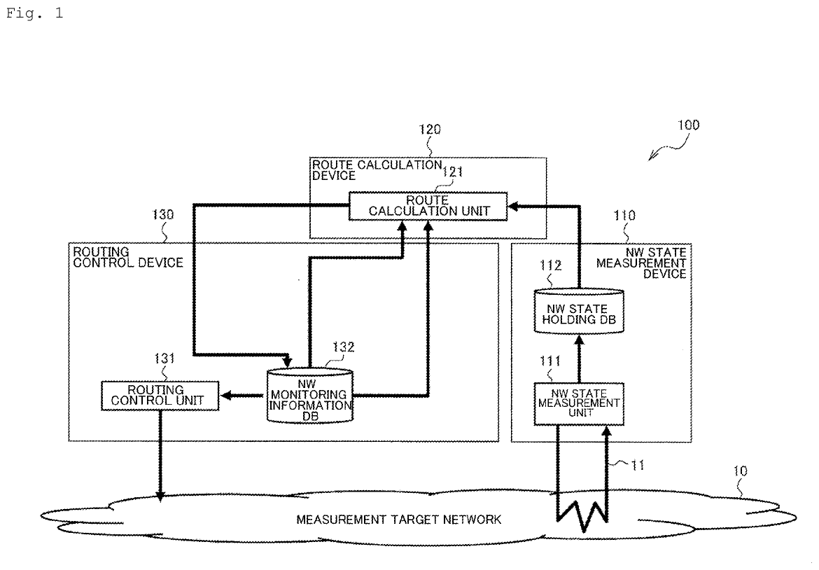

FIG. 1 is a diagram illustrating an example of configuration of a network control system 100 according to the embodiment of the present invention.

As shown in FIG. 1, a network control system 100 includes an NW state measurement device 110, a route calculation device 120, a route control device 130 and is constructed. The network control system 100 is connected to a measurement target network (a communication network) 10.

The NW state measurement device 110, the route calculation device 120, and the route control device 130 constituting the network control system 100 may be realized by independent devices, it may be realized by one device. The function deployment in each component is an example, and the function deployment between the devices may be changed.

### <Communication Network>

The measurement target network (communication network) 10 is constituted of a physical link connecting nodes and nodes. On the measurement target network 10, topology information is advertised by an information of a routing protocol (OSPF-LS/BGP-LS, and the like) which is a routing protocol operating in the measurement target network 10. The network control system 100 performs transfer on the measurement target network 10 by a protocol capable of performing route control in units of a flow and a virtual Private Network (VPN), such as MPLS/Segment Routing (SR) and Openflow (registered trademark), by using a protocol capable of performing route control in units of a flow and a virtual Private Network VPN. /227>

### <NW State Measurement Device 110>

The NW state measurement device 110 (FIG. 1 reference) includes an NW state measurement unit 111 and an NW state holding DB 112.

An NW state measurement unit 111 measures and collects an NW topology, a delay amount of each link, a jitter, a traffic amount, a link band and stores in an NW state holding DB 112 (NW state holding unit).

The NW topology is collected from information of a routing protocol (OSPF-LS/BGP-LS, etc.) operating in the measurement target network. The NW topology is used to calculate the delay amount of each link.

The delay amount and jitter of each link are measured by ping, TWAMP (Two-Way Active Measurement Protocol), a packet for delay measurement or the like.

The traffic volume is acquired by a Simple Network Management Protocol (SNMP)/Telemety (registered trademark), which acquires information on a traffic counter and device information inside the NW device (hereinafter merely “device”).

The link band is collected from the config or the like of the device. Information which does not change dynamically, such as NW topology and band, may be manually input.

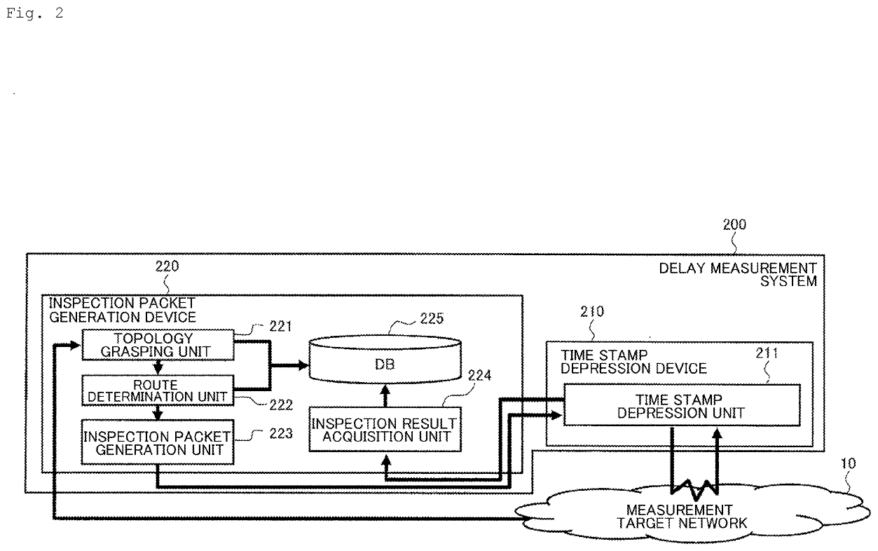

The NW state measurement device 110 uses a delay measurement system 200, which executes highly accurate measurement of delay and jitter in real time (FIG. 2 reference). When the delay measurement system 200 is used, the NW state measurement unit 111 performs time stamp processing by hardware when transmitting and receiving a probe packet, and measures the NW state from a difference of the time stamp at the time of transmitting and receiving the probe packet.

### <Route Calculation Device 120>

The route calculation device 120 (FIG. 1 reference) include a route calculation unit 121.

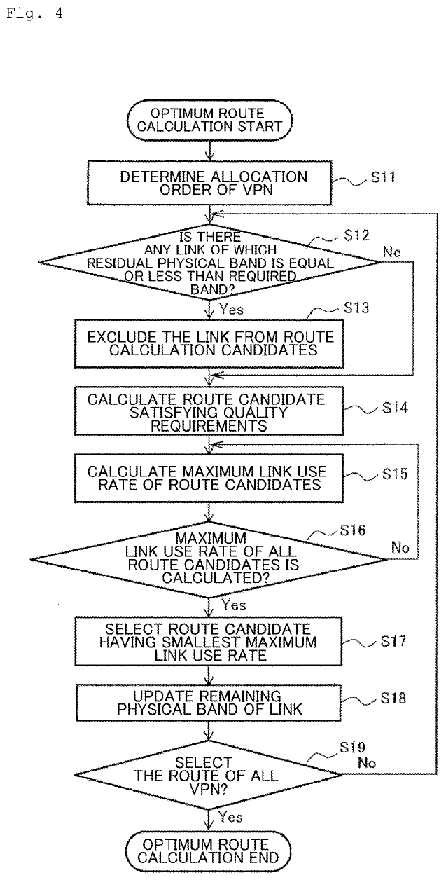

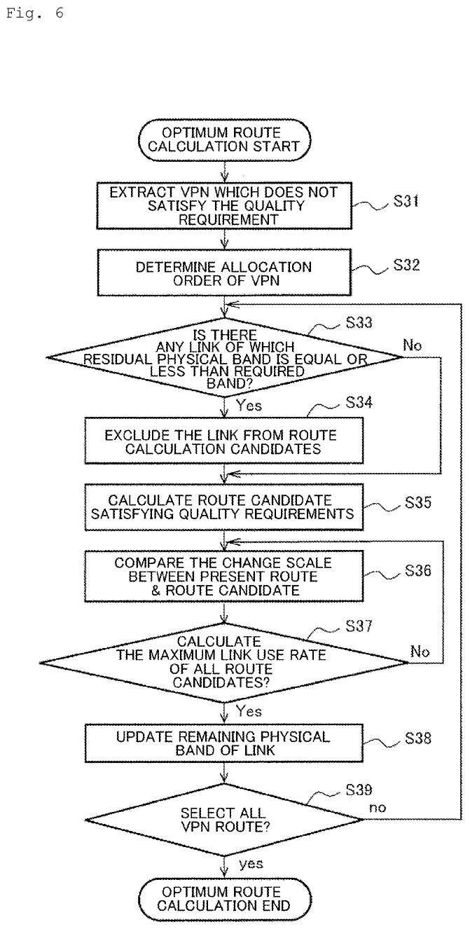

A route calculation unit 121 calculates an optimum route from the information of the NW state holding DB 112 and the NW design information holding DB 132 (NW design information holding unit) of the route control device 130. An example of the optimization calculation of the route calculation unit 121 will be described later with reference to the flow of FIG. 4 and FIG. 6.

An NW design information holding DB 132 holds information on an endpoint, a delay quality requirement, and a required band, and registers the information as design information of each NW in advance.

The NW design information holding DB 132 collects and holds the current route information from the config of the device. The route information may be manually input. In addition, the current route information may be omitted for a state in which any NW is not allocated or for a new NW to be added.

### <Route Control Device 130>

The route control device 130 (FIG. 1 reference) includes a route control unit 131 and an NW design information holding DB 132.

A route control unit 131 performs route control on the basis of the route information calculated by the route calculation device 120. The route control unit 131 realizes, for example, transfer in a network by a label switching method such as MPLS/Segment Routing (SR), or by a method which is available for control of an NW unit or any flow control in units of NW such as Openflow (registered trademark). Thus, flexible control in units of NW can be performed.

When the route control is completed, the route control unit 131 updates the NW design information holding DB 132 as current route information. The route control unit 131 does not perform route control or update of information for an NW having no change in the route before and after the route calculation.

### [The Configuration of an NW State Measurement Device 110 (Delay Measurement System)]

FIG. 2 is a block diagram showing the configuration of the delay measurement system 200 according to the technology described in NPL 1. In the present embodiment, the NW state measurement device 110 has the structure of the delay measurement system 200 shown in FIG. 2 in the background. The delay measurement system 200 shown in FIG. 2 includes a time stamp depression device 210 executed by H/W (Hardware) processing, and an inspection packet generation device 220 executed by S/W (Software) processing.

The time stamp depression device 210 includes a time stamp depression unit 211.

A time stamp depression unit 211 performs stamping of a time stamp when transmitting and receiving the probe packet. Specifically, the time stamp depression unit 211 stamps time stamp information into a probe packet. For example, time stamp information (Tin) when a probe packet generated by an inspection packet generation device 220 is transmitted from a time stamp depression device 210 and time stamp information (Tout) when the probe packet is transferred in the NW and received by the time stamp depression device 210 are stamped.

The inspection packet generation device 220 includes a topology grasping unit 221, a route determination unit 222, an inspection packet generation unit 223, an inspection result acquisition unit 224, DB 225.

The topology grasping unit 221 collects NW information. Specifically, the topology grasping unit 221 is connected to the measurement target network 10 by a routing protocol, and collects NW topology information necessary for route calculation, and segment identifier (SID) information necessary for route control when transfer is performed by SR. The route determination part 222 calculates a delay measurement route on the basis of the NW topology information.

The inspection packet generation unit 223 generates a probe packet to be transmitted into the NW. Specifically, the inspection packet generation unit 223 engrave a time Tin when transmitting to the measurement target network 10 and a time Tout when returning to an arbitrary place in the inspection packet by a time stamp depression unit 211. The inspection packet generation part 223 stacks SR-SID labels so as to be transferred according to the route calculated by the route determination unit 222.

The inspection result acquisition unit 224 performs delay time calculation. Specifically, the inspection result acquisition unit 224 calculates RTT from time stamp information in the probe packet. A difference between Tout and Tin punched by the time stamp depression device 210 is calculated, and stored in a DB 225 as RTT of a corresponding measurement path. The DB 225 stores information collected and calculated by each part.

The delay measurement system 200 measures a delay time without performing time stamp processing in the NW or time synchronization between devices by performing time stamp processing when transmitting and receiving the probe packet. It is not necessary to perform the return processing of the probe packet in the NW, time stamp processing, and time synchronization between devices.

Further, by performing the time stamp processing by hardware, the influence of the CPU load and other processing can be minimized, and the time information can be processed with high accuracy and high frequency. Thus, the measurement conventionally performed at the accuracy of millisecond and the interval of second can be measured at the accuracy of microsecond and the interval of millisecond.

Further, by combining the path control of the probe packet with a flexible path controllable protocol such as SR (Segment Routing), the delay of each link or an arbitrary section can be measured.

The delay measurement system 200 shown in FIG. 2 is applied to the NW state measurement device 110 shown in FIG. 1. The NW state measurement device 110 can perform high-accuracy measurement of the delay amount and jitter in real time by using the delay measurement system 200.

The operation and route calculation method of the network control system 100 having the above-described structure will be described below.

It is assumed that topology information is advertised by a routing protocol such as OSPF and BGP on the measurement target network 10, and can be transferred by a protocol such as MPLS/Segment Routing (SR) or Openflow (registered trademark) capable of route control in units of a flow or Virtual Private Network (VPN).

### [Procedure]

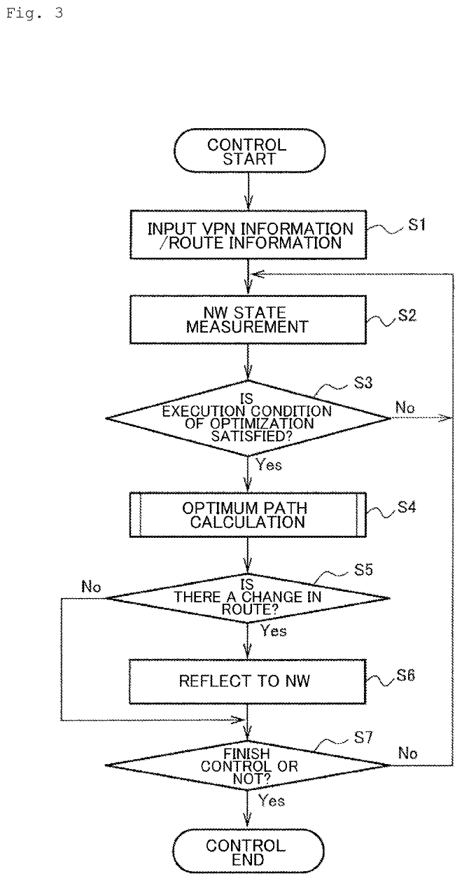

Referring to FIG. 3 to FIG. 6, the procedure of the route calculation method of the network control system 100 will be described.

### <Overall Flow>

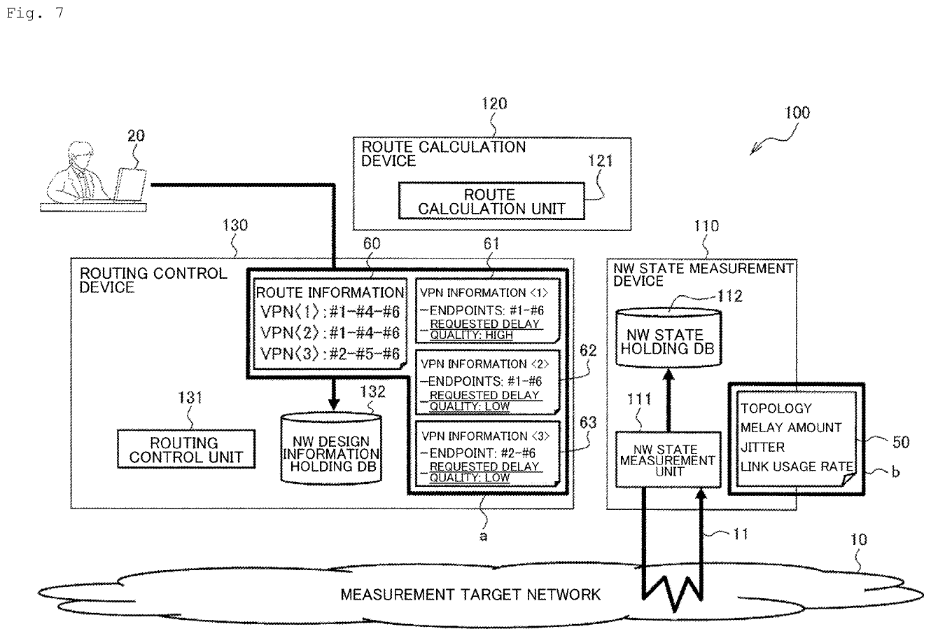

FIG. 3 is a flowchart showing the procedure of the route calculation method of the network control system 100. In a step S1, a user inputs VPN information (NW design information)/route information, and stores VPN information (NW design information)/route information to the NW design information holding DB 132, with a terminal device 20 (FIG. 7 reference). When setting is already performed in the device, the VPN information is acquired from the device via the route control unit 131.

The VPN information (NW design information) includes information on the input/output point of the VPN, the delay quality requirement (the amount of delay, the jitter, and the like), and the necessary band. The NW design information is input for each stored flow or VPN.

The route information is input in accordance with the present setting state or collected from route information and flow information set in the device. For the NW whose route is not yet set, the route information may be omitted.

In a step S2, the NW state measurement unit 111 measures an NW state. Specifically, the NW state measurement unit 111 measures the NW state by collecting information on topology, delay amount and jitter for each link, and link use rate from the communication network, and stores the information in the NW state holding DB 112.

The topology is obtained by route information of the routing protocol (OSPF-LS/BGP-LS, etc.). The delay amount is measured with ping between nodes, or calculated from the Round Trip Time (RTT) by transmitting a packet for measurement delay to the inside of the measurement target network (communication network) 10. The jitter is obtained from a delay amount measured a plurality of times.

The link use rate is calculated from the current traffic amount to the physical band of each link or the ratio of the required band inputted as NW design information. For example, when the physical band of a certain link is 10 G and the traffic amount is 1 G, the utilization rate of the link is 1 G/10G×100%=10%.

In a step S3, the route calculation unit 121 determines whether or not an execution condition of optimization is satisfied. When the optimization execution condition is not satisfied (the step S3: No), the route calculation unit 121 returns to the step S2 and continues NW state measurement. When an execution condition of optimization is satisfied (the step S3: Yes), a route calculation unit 121 calculates an optimum route in a step S4. Specifically, the route calculation unit 121 calculates an optimum route of each NW on the basis of information in the NW state holding DB 112 and the NW design information holding DB 132 at every lapse of a fixed time or when an execution condition of optimization calculation is satisfied. The execution condition of the optimization calculation may be a case where the value of the measured NW state exceeds a predetermined threshold or a case where the NW which does not satisfy the quality requirement exceeds a fixed number.

A specific example of the optimum route calculation will be described later with reference to the optimization calculation example 1 to 3 using the subroutine shown in FIG. 4 to FIG. 6.

In a step S5, the route control device 130 (FIG. 1 reference) discriminates whether or not there is a change in the route. When there is a change in the route (the step S5: Yes), the route control device 130 reflects the change in the NW in a step S6, and advances to a step S7. When there is no change in the route (the step S5: No), the route control device 130 proceeds to a step S7 as it is.

The route control device 130 determines whether to end processing in the step S7. When the route control device 130 does not finish the control (the step S7: No), the route control device 130 returns to the step S2, and continues processing of the NW state measurement and following processing.

When the route control device 130 ends the control (the step S7: Yes), the route control device 130 ends the processing of the present flow in the step S7.

### <Optimization Calculation Example 1>

The optimization calculation example 1 is an example in which the maximum link use rate in the NW is minimized.

The maximum link use rate refers to the maximum utilization rate among the utilization rates of all links in the NW. For example, when there are three links in the NW and their utilization rates are 30%, 50%, and 10%, the maximum link use rate is 50%.

FIG. 4 is a flow chart showing the optimum route calculation when the maximum link use rate in the NW is minimized. The operation of FIG. 4 is called by Subroutine Call of the step S4 in FIG. 3 and executed.

In a step S11, a route calculation unit 121 determines the allocation order of the VPN. Specifically, the route calculation unit 121 rearranges the NW to be allocated in the order of higher delay quality requirements, that is, in the order of smaller allowable delay amount and jitter, as the order of determining allocation.

Thereafter, a plurality of route candidates of each NW satisfying the quality requirements are calculated in the determined order.

In a step S12, a route calculation unit 121 discriminates whether or not there is a link in which the remaining physical band of the link is equal to or less than the request band. Specifically, when the remaining physical band of each link is lower than the required band of the VPN, the route calculation unit 121 excludes the link from the route calculation. For example, in the case when the remaining physical band of a certain link is 0.1 G, and the required band of a certain VPN is 0.2, since the link cannot be allocated, the link is previously excluded from the object of route calculation.

When there is a link in which the remaining physical band of the link is equal to or less than the request band (the step S12: Yes), in a step S13, the route calculation unit 121 excludes the link from the route calculation candidates. When there is no link in which the remaining physical band is equal to or less than the request band (the step S12: No), the route calculation unit 121 skips the step S13 and proceeds to a step S14.

In the step S14, the route calculation unit 121 calculates a route candidate satisfying the quality requirement. Specifically, the route calculation unit 121 calculates a route by using the Dijkstra method or the like with the delay amount and jitter of each link as link costs between the input and output points of VPN information (NW design information). Further, in this route calculation, not only a route in which the total link cost becomes minimum, but also a plurality of routes in which the value of link quality becomes equal to or less than the value of the quality requirement is calculated as follows.

In a step S15, a route calculation unit 121 calculates the maximum link use rate of the route candidate.

The calculation of the maximum link use rate will be described.

The required band of the VPN is added to the allocated band of each link on the optimum route calculation in the step S15 to calculate a link use rate. For example, when the physical band of a certain link is 10 G, the allocated band is 2 G, and the required band of the VPN is 1 G, the allocated band is 2 G to 3 G, the link use rate is calculated from 20% to 30%. At this time, when there is a plurality of route candidate, link use rates are calculated for all the route candidates to calculate a maximum link use rate from among those link use rates, and a route candidate is selected so that the maximum link use rate in the communication NW is minimized. When only one route candidate exists, it is selected.

Thus, not only the route where the total link cost becomes minimum but also a plurality of route where the total link cost becomes equal to or less than the value of the quality requirement is calculated and selected from them, thereby it is possible minimizing the maximum link use rate while satisfying the quality requirement. When there is no path in which the total value of link costs is equal to or less than the delay amount or jitter given by the required quality, the path in which the total value becomes the smallest value may be selected as the optimum path, or it may be determined that the required quality given is inappropriate, by determining that there is no path satisfying the quality requirement.

In a step S16, the route calculation unit 121 determines whether or not the maximum link use rate of all route candidates is calculated.

When the maximum link use rate of all the route candidates is calculated (the step S16: Yes), the route calculation unit 121 proceeds to a step S17, and when the maximum link use rate of all the route candidates is not calculated (the step S16: No), the route calculation unit 121 returns to the step S15.

In a step S17, the route calculation unit 121 selects a route candidate having the smallest maximum link use rate.

In a step S18, a route calculation unit 121 updates the remaining physical band of the link.

In a step S19, the route calculation unit 121 determines whether or not the route of all the VPN is selected.

When the route of all the VPNs is not selected (the step S19: No), the route calculation unit 121 returns to the step S12.

When the routes of all the VPN are selected (the step S19: Yes), the route calculation unit 121 finishes the optimum route calculation processing of the present flow and returns to the step S5 in FIG. 3.

The above procedure is performed for all the NW to determine the route information.

### <Optimization Calculation Example 2>

The optimization calculation example 2 is an example in which the sum of the delay amount and jitter of each NW is minimized.

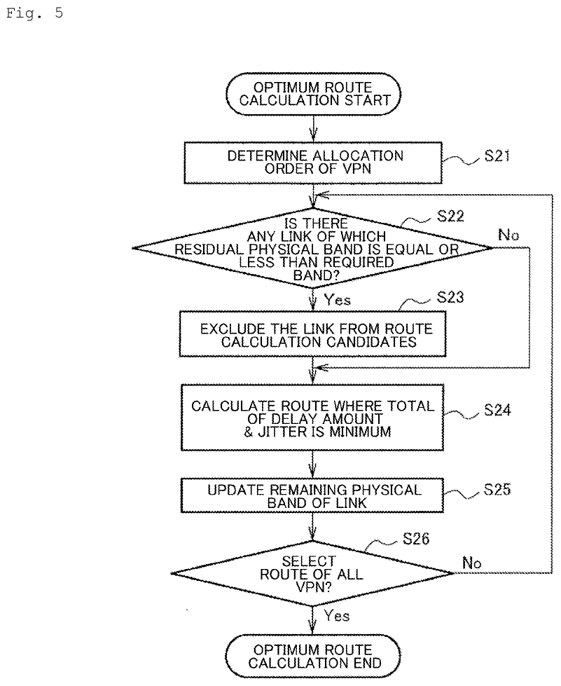

FIG. 5 is a flow chart showing the optimum route calculation when the total of the delay amount and jitter of each NW is minimized. The operation of FIG. 5 is called by a Subroutine Call of a step S4 in FIG. 3 and executed.

In a step S21, a route calculation unit 121 determines the allocation order of the VPN. Specifically, the route calculation unit 121 rearranges the NW to be allocated in the order of higher delay quality requirements, that is, in the order of smaller allowable delay amount and jitter, as the order of determining allocation, similarly to the step S11 of FIG. 4.

In a step S22, the route calculation unit 121 determines whether there is a link whose remaining physical band of the link is equal to or less than a request band. Specifically, the route calculation unit 121 excludes the link from the route calculation when the remaining physical band of each link is lower than the required band of the VPN, similarly to the step S12 in FIG. 4.

When there is a link in which the remaining physical band of the link is equal to or less than the request band (the step S22: Yes), the route calculation unit 121 excludes the link from the route calculation candidates in a step S23. When there is no link in which the remaining physical band of the link is equal to or less than the request band (the step S22: No), the route calculation unit 121 jumps the step S13, and proceeds to a step S24.

In a step S24, the route calculation unit 121 calculates a route for minimizing the total link cost by using a Dijkstra method or the like with the delay amount and jitter of each link as link cost between the input/output points of each NW. At this time, the allocatable band of each link is compared with the required band of the VPN, and when the allocatable band is insufficient, the link is excluded from the route calculation object.

In a step S25, the route calculation unit 121 adds a necessary band to the allocated band of each link on the calculated optimum route (update of the residual physical band of the link), and updates the route information.

In a step S26, the route calculation unit 121 determines whether or not the routes of all the VPN are selected. When the route of all the VPNs is not selected (the step S26: No), the route calculation unit 121 returns to the step S22 described above. When the routes of all the VPN are selected (the step S26: yes), the route calculation unit 121 finishes the optimum route calculation processing of the present flow and returns to the step S5 in FIG. 3.

The above procedure is performed for all the NW to determine the route information.

### <Optimization Calculation Example 3>

The optimization calculation example 3 is an example in which the path change scale is minimized.

FIG. 6 is a flow chart showing the optimum route calculation when the route change scale is minimized. The operation of FIG. 6 is called by a Subroutine Call of the step S4 in FIG. 3 and executed.

In a step S31, a route calculation unit 121 determines whether or not quality requirements are satisfied from the current route information of each NW, and extracts only VPN which does not satisfy the requirements.

In a step S32, a route calculation unit 121 determines the allocation order of the VPN. Specifically, the route calculation unit 121 rearranges the NW to be allocated in the order of higher delay quality requirements, that is, in the order of smaller allowable delay amount and jitter, as the order of determining allocation.

Thereafter, a plurality of route candidates of each NW satisfying the quality requirements is calculated in the determined order.

In a step S33, a route calculation unit 121 determines whether or not there is a link in which the remaining physical band of the link is equal to or less than the request band.

Specifically, when the remaining physical band of each link is lower than the required band of the VPN, the route calculation unit 121 excludes the link from the route calculation.

When there is a link in which the remaining physical band of the link is equal to or less than the request band (the step S33: Yes), in a step S34, the route calculation unit 121 excludes the link from the route calculation candidates. When there is no link in which the remaining physical band of the link is equal to or less than the request band (the step S33: No), the route calculation unit 121 jumps the step S34 and proceeds to a step S35.

In a step S35, a route calculation unit 121 calculates a route candidate satisfying the quality requirement. Specifically, the route calculation unit 121 calculates a route between the input/output points (endpoint) of VPN information (NW design information), and node points by using a Dijkstra method or the like with the delay amount and jitter of each link as link costs.

In a step S36, a route calculation unit 121 compares the change scale between the present route and each route candidate. Specifically, the route calculation unit 121 selects the route candidates having the smallest difference from the current route information as the optimum route, and allocates the required band and updates the route information. For example, the current path is #(hereinafter, in the present specification, “#” indicates an identifier number of a device. In this case, #1 and #5 are also input/output point (endpoint)) #1-#2-#3-#4-#5, when there are two route candidates after change #1-#6-#3-#4-#5 and #1-#2-#7-#8-#5, the former will be changed in one location and the latter in two locations. Therefore, the route calculation unit 121 determines that the former has a smaller change scale, and selects the former as a new candidate.

In a step S37, the route calculation unit 121 determines whether or not the maximum link use rate of all route candidates is calculated.

When the maximum link use rates of all the route candidates are calculated (the step S37: Yes), the route calculation unit 121 proceeds to a step S38, and when the maximum link use rate of all the route candidates is not calculated (the step S37: No), the route calculation unit 121 returns to the step S36.

In a step S38, a route calculation unit 121 updates the remaining physical band of the link.

In a step S39, the route calculation unit 121 determines whether or not the routes of all the VPN are selected. When the routes of all the VPN are not selected (the step S39: No), the route calculation unit 121 returns to the step S33. When the routes of all the VPN are selected (the step S39: Yes), the route calculation unit 121 finishes the optimum route calculation processing of the present flow and returns to the step S5 in FIG. 3.

The above procedure is performed for all the NW to determine the route information.

### [Operation of Network Control System 100]

Referring to FIG. 7 to FIG. 11, operation of the network control system 100 will be described.

### <Initial State>

In an initial state, the network control system 100 performs input of VPN information and route information, and NW state measurement.

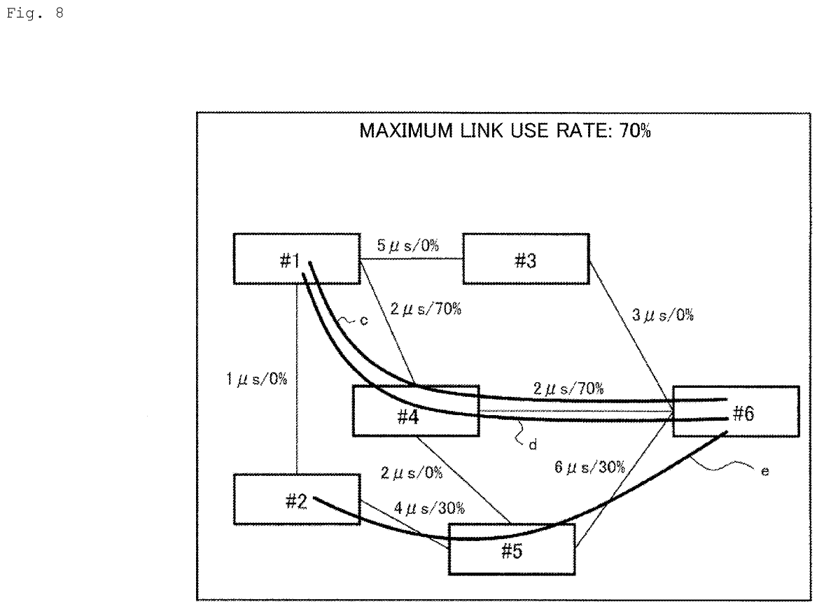

FIG. 7 is a figure illustrating operation in the first state of the network control system 100 in FIG. 1. FIG. 8 is a diagram showing the input/output point (endpoint) (#1 to #6) of the VPN information (NW designation information) stored in the NW state holding DB 112 in FIG. 7, and the delay amount, jitter [sec], and the link use rate [%] in the links between the input/output point (endpoint) (#1 to #6).

VPN Information (NW Design Information) Input

The VPN information (NW design information) input will be described.

The route control device 130 of the network control system 100 acquires VPN information (NW design information). The VPN information may be acquired from the VPN information input by a user, or from the device via the route control unit 131 when the VPN information is already set in the device. The case of inputting VPN information by the user is taken as an example.

As shown by a symbol “a” in FIG. 7, with the terminal device 20, the user inputs VPN information 61 to 63 (VPN information <1> to <3>) to the route control device 130, inputs the route information 60, and stores them in the NW design information holding DB 132.

VPN information 61 to 63 (VPN information<1> to <3>) are information on the input/output point (endpoint) of the VPN, the delay quality requirement (delay amount and jitter, and the like), and the necessary band, which are input for each stored flow or VPN.

The VPN information 61 (VPN information<1>), in the input/output point (endpoint) (#1 to #6) showed in FIG. 8, includes the information of the delay amount and jitter (herein after, “delay amount and jitter” is referred simply as “delay amount”) [sec] and the information of the required band [Gbps] of the link between the endpoint: #1 to #6, and a requested delay quality of the VPN (here requested delay quality is “High”). It is assumed that the VPN information of the VPN 61 is the information of the required band 4 [Gbps].

The VPN information 62 (VPN information <2>), in the input/output point (endpoint) (#1 to #6) showed in FIG. 8, include the delay amount [sec] and the information of the required band [Gbps] of the link between the endpoint: #1 to #6, and the request delay quality of the VPN (here requested delay quality is “Low”). It is assumed that the VPN information of the VPN 62 is information of the required band 3 [Gbps]. The VPN information 63 (VPN information <3>), in the input/output point (endpoint) (#2-#6) showed in FIG. 8, include the delay amount [sec] of the link between endpoints: #2-#6 and the information of the required band [Gbps] of the link between the endpoint: #2 to #6, and the request delay quality of the VPN (here requested delay quality is “Low”). It is assumed that the VPN information of the VPN 63 is the information of the required band 4 [Gbps].

The route information 60 is route control information for each VPN <1> to <3>. In this case, the route information 60 includes VPN at the input/output point (endpoint) (#1-#6) showed in FIG. 8: VPN <1>: #1-#4-#6, VPN <2>: #1-#4-#6, VPN <3: #2-#5-#6. In the case of the VPN unallocated state, the route information 60 is not essential.

NW State Measurement

The NW state measurement will be described.

The NW state measurement device 110 of the network control system 100 measures an NW state (topology, a delay amount of each link, and a link use rate), and grasps an initial state. The link use rate is not information associated with each VPN but information managed as an NW state.

As shown by a symbol “b” in FIG. 7, the NW state measurement unit 111 transmits and receives a predetermined probe packet to and from a measurement target network 10 via a communication path 11 to measure an NW state, NW state measurement information 50 composed of topology, delay amount of each link, and a link use rate is stored in an NW state holding DB 112. Here, the NW state measurement device 110 uses the NW state measurement of the delay measuring system 200 shown in FIG. 2. Thus, the measurement can be performed with the precision of microseconds and at intervals of milliseconds.

FIG. 8 is an image diagram reflecting the result of the NW state measurement (delay amount/jitter [sec], and link use rate [%]) to the links between the input/output point (endpoint) (#1-#6) of the VPN information (the NW design information) held in the NW design information holding DB 132. Further, as shown by a thick solid line c to e in FIG. 8, VPN <1> to <3> based on the route information 60 (FIG. 7 reference) are superimposed on the links between input/output points (endpoint) (#1-#6).

For example, the amount of delay of the link between the measured endpoints: #1-#3 is 5 μs [sec]/link use rate is 0 [%]. Further the delay amount of the link between the endpoints: #3-#6 is 3 μs[sec]/link use rate is 0 [%]. Further, the delay amount of the link between the endpoints: #1-#4 is 2 μs [sec]/link use rate is 70 [%], the delay amount of the link between the endpoints: #4-#6 is 2 μs [sec]/link use rate is 70 [%]. Similarly, the measured delay amount of the link between the respective endpoints #1-#6 are held in an NW state holding DB 112.

Now, the maximum link use rate [%] is obtained from the NW state measurement result of VPN information 61 to 63 (VPN information <1> to <3>) based on the route information 60 shown in FIG. 7.

For example, the maximum link use rate [%] of #1-#4 is that the physical link band is 10 G, the request band of passing VPN <1>, VPN <2> is 4 Gbps, 3 Gbps respectively. For this reason, the maximum link use rate [%] of #1-#4 is calculated as (4+3)/10=0.7 (70%) (thick solid line c, d in FIG. 8 reference).

Here, as it can be seen from the route information 60 shown in FIG. 7, the VPN <1> and the VPN <2> are the same in that they are route information connecting the endpoints: #1-#4-#6. However, as it is known by comparing the VPN information 61 (VPN information<1>) and VPN information 62 (VPN information<2>) shown in FIG. 7, the VPN1> and the VPN<2> are different in the requested delay quality (the requested delay quality of the VPN information<1> is “High”, and the requested delay quality of the VPN information <2> is “Low”).

Returning to the description of FIG. 8, the maximum link use rate [%] of #2-#6 is similarly calculated as 0.3 (30%)</1097 (a thick solid line e in FIG. 8 reference).

In FIG. 8, the maximum link use rate which is the maximum link use rate among the link use rates is 70 [%].

### <Route Calculation>

In route calculation, the network control system 100 inputs the NW state, VPN information, and route information, the route calculation device 120 calculates the optimum route of each VPN.

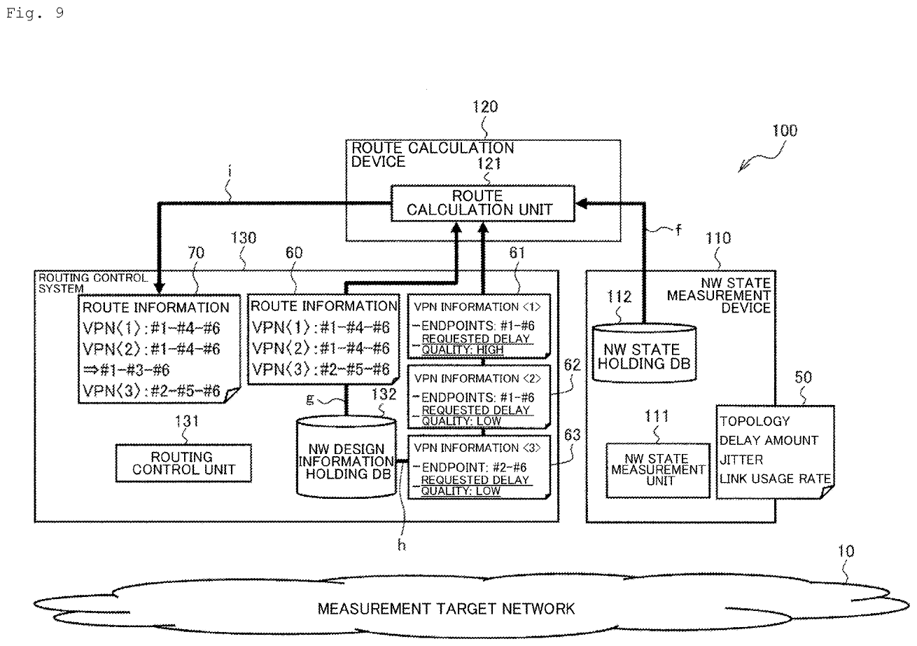

FIG. 9 is a diagram explaining the operation of route calculation of the control system 100 in FIG. 1. The same portions as those in FIG. 7 are assigned the same reference symbol, and a description about overlap portions are omitted. The NW state measurement device 110 outputs the NW state held in the NW state holding DB 112 to a route calculation unit 121 of the route calculation device 120 (symbol “f” in FIG. 9 reference).

The route control device 130 outputs the route information 60 held in the NW design information holding DB 132 to a route calculation unit 121 (symbol “g” in FIG. 9 reference), and outputs the VPN information 61 to 63 (VPN information <1> to <3>) held in the NW design information holding DB 132 to the route calculation unit 121 (symbol “h” in FIG. 9 reference).

A route calculation unit 121 of a route calculation device 120 inputs the NW state held in the NW state holding DB 112, and the route information 60 and VPN information 61 to 63 held in the NW design information holding DB 132, and the route calculation unit 121 calculates the optimum route of the VPN. It is assumed here that the calculated optimum path of the VPN is route information 70. In the route information 70, the route of the route information 60 held in the NW design information holding DB 132 is optimized. That is, among the route information 60 held in the NW design information holding DB 132, the route information 60 obtained by changing the VPN <2>: #1-#4-#6 to VPN<2>: #1-#3-#6 is output (displayed to user) as the route information 70 (described later).

A route calculation unit 121 calculates an optimum route of the VPN (described later) by using an “objective function” (described later) for evaluating the optimization degree of the calculation result and a “constraint condition” which the route calculation result needs to satisfy.

The calculation of the optimum path of the VPN, that is, the optimization example of the VPN will be described.

The “objective function” in the VPN optimum route calculation includes the minimization of the maximum link use rate, the minimization of the standard deviation of the link use rate in the NW, the minimization of the standard deviation of the number of VPN allocated for each link, the number of times of route change is minimized, and the like.

The “constraint condition” in the VPN optimum route calculation may be such that the route of each VPN satisfies the requested delay quality, or the links to be allocated for each requested quality are separated.

### <Update>

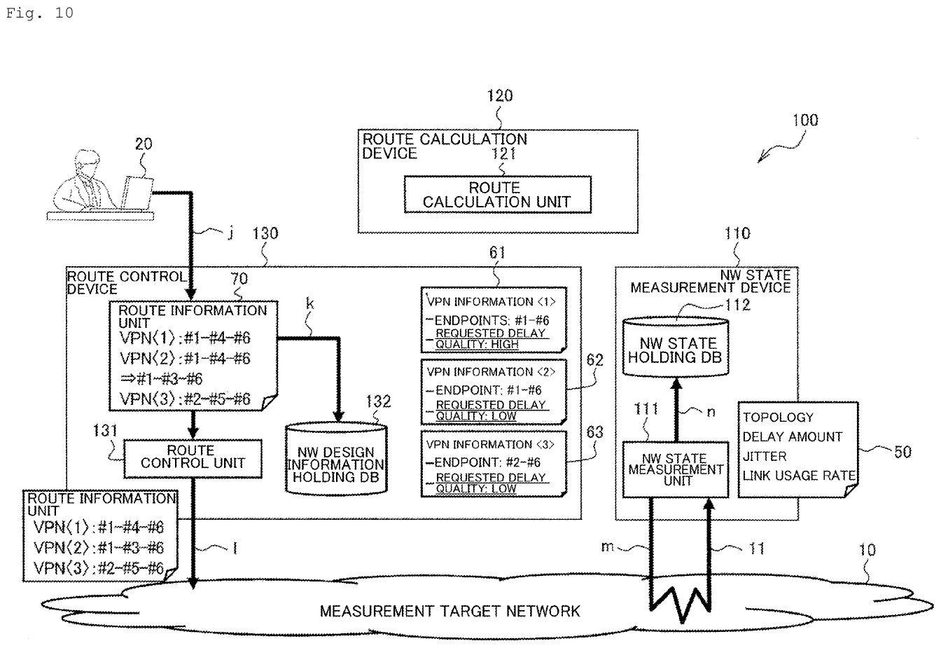

FIG. 10 is a diagram explaining update operation of the network control system 100 in FIG. 1. The same portions as those in FIG. 7 and FIG. 9 are assigned the same reference symbols, and a description about overlap portions are omitted.

The VPN Information (NW Design Information) are Reflected

A route control device 130 of the network control system 100 acquires VPN information (NW design information).

As shown by the symbol “j” in FIG. 10, a user inputs the route information 70 to the route control device 130 by using the terminal device 20 and stores it in the NW design information holding DB 132. The route information 70 is route control information for each VPN <1> to <3> set by the user. In this case, the route information 70 is the optimum route of the VPN calculated by the route calculation unit 121 and is confirmed and set by a user. In the route information 70, the VPN <2>: #1-#4-#6 of the route information 60 is changed to the VPN <2>: #1-#3-#6.

A route control unit 131 of a route control device 130 confirms the calculated optimum route candidate, and when reflection is instructed from a terminal device 20 of a user, updates the NW design information holding DB 132 (the symbol “k” in FIG. 10 reference) and inputs and sets to a measurement target network 10 (the symbol “I” reference).

NW State Measurement

The NW state measurement unit 111 of the NW state measurement device 110 acquires an NW state after route control (topology, a delay amount of each link, and a link use rate). As shown by symbol “m” in FIG. 10, the NW state measuring unit 111 transmits and receives a predetermined probe packet to and from measurement target network 10 via the communication path 11 to measure the NW state. The NW state measurement part 111 updates the initial state on the basis of the acquired NW state after the route control.

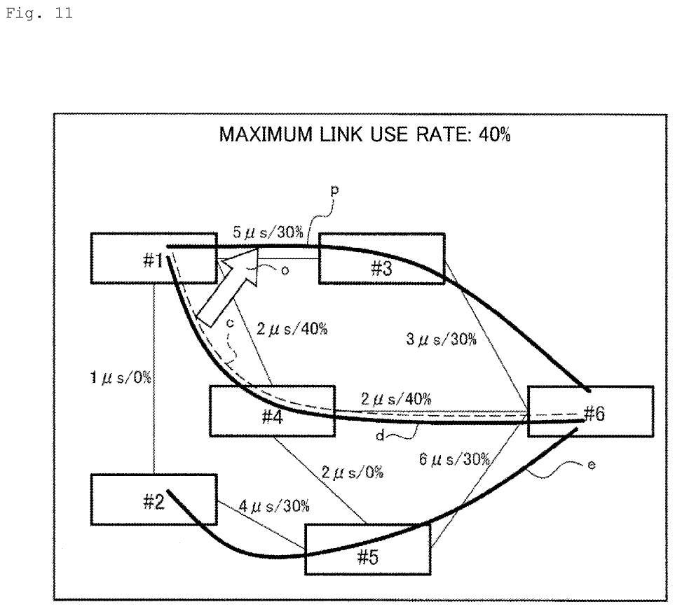

FIG. 11 is an image diagram showing the NW state (a delay amount/jitter [sec], a link use rate [%]) of the link reflected the result of NW state measurement after the route control; the rout Further, as shown by a thick solid line c to line e in FIG. 8, a VPN <1> to <3> based on the route information 60 (FIG. 7 reference) is superimposed on the link between the input/output point (endpoint) (#1-#6). The same or corresponding portions as those in FIG. 8 are denoted by the same reference symbols.

The delay amount measured after route control of the link between the endpoints: #1-#3 is 5 μs [sec]/link use rate is 30 [%]. Further, the delay amount of the link between the endpoints: #3-#6 is 3 μs [sec]/link use rate is 30[%]. Further, the delay amount of the link between the endpoints: #1-#4 is 2 μs [sec]/link use rate is 40 [%], the delay amount of the link between the endpoints: #4-#6 is 2 μs[sec]/link use rate is 40 [%].

Now, the maximum link use rate [%] is obtained from the NW state measurement result of VPN information 61 to 63 (VPN information <1 to <3>) based on the route information 70 shown in FIG. 10.

The VPN <1> is route information connecting the endpoints: #1-#4-#6, the delay amount and the link use rate of the link between #1-#4 measured after route control is 2 μs/40[%], the delay amount and the link use rate of the link between #4-#6 is 2 μs/40[%] (thick solid line d in FIG. 11 reference). The VPN <1> is not changed from the route information in the initial state shown in FIG. 8.

On the otherhand, for VPN <2>, as it can be seen from the route information 70 shown in FIG. 10, VPN<2>: #1-#4-#6 (dashed line c in FIG. 11 reference) is changed (white space on a background arrow o in FIG. 11 reference) to VPN<2>: #1-#3-#6 (thick solid line p in FIG. 8 reference). That is, in the initial state shown in FIG. 8, the route information are the two pieces of route information connecting the endpoints: #1-#4-#6 VPN<1> and VPN<2>, then after update, VPN<2>: #1-#4-#6 (dashed line c in FIG. 11 reference) is changed to VPN<2>: #1-#3-#6 (thick solid line p in FIG. 11 reference) which is a route not to go by way of #4.

Here, as it can be seen from VPN information 61 and 62 shown in FIG. 10, VPN <1> and VPN <2> are the same in that they are route information connecting the endpoints: #1-#6, but VPN<1> and VPN<2> have different requested delay quality (VPN information <1> has the requested delay quality “High”, VPN information <2> has the requested delay quality “Low”). Therefore, the VPN <2>: #1-#4-#6 of the requested delay quality “Low” is changed to the VPN <2>: #1-#3-#6.

The VPN<2> shown in FIG. 10 is a route information connecting endpoints: #1-#3-#6 (thick solid line p in FIG. 11 reference).

The VPN<3> shown in FIG. 10 is a route information connecting endpoints: #2-#5-#6 (thick solid line e in FIG. 8 reference).

The VPN <3> is not changed from the route information in the initial state shown in FIG. 8.

In FIG. 11, the maximum link use rate is 40 [%], and the maximum link use rate 70 [26] in FIG. 8 can be reduced to the maximum link use rate 40 [%].

In this way, the NW state measurement unit 111 acquires the NW state after the route control, and updates the initial state. By periodically performing a series of NW state measurements to route control, optimum control corresponding to the NW state is realized.

### [Hardware Configuration]

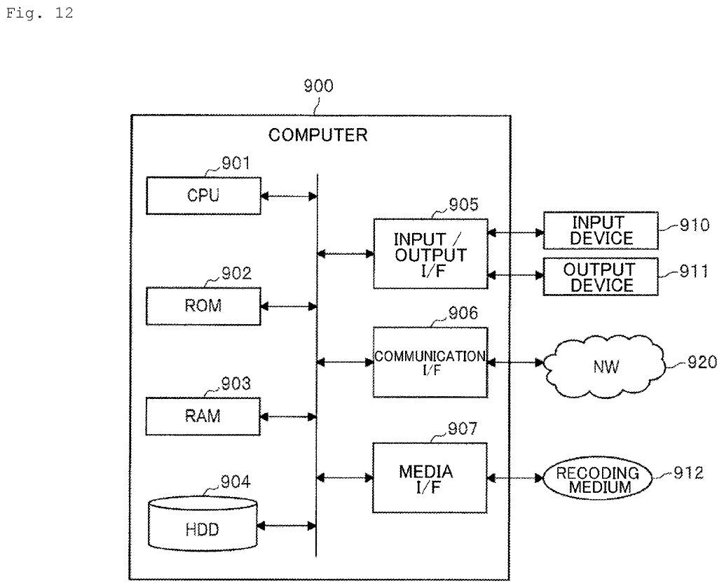

The route calculation method according to the present embodiment is realized by, for example, a computer 900 having a configuration as shown in FIG. 12.

FIG. 12 is a hardware configuration diagram showing an example of a computer that realizes processing of the route calculation method according to the present embodiment. The computer 900 includes a CPU (Central Processing Unit) 901, a ROM (Read Only Memory) 902, a RAM 903, an HDD (Hard Disk Drive) 904, an input/output I/F (Interface) 905, a communication interface I/F 906 and a media I/F 907.

The CPU 901 operates on the basis of a program stored in the ROM 902 or the HDD 904 and performs control by each unit of the network control system 100 shown in FIG. 1. The ROM 902 stores a boot program executed by the CPU 901 when the computer 900 is started, a program related to the hardware of the computer 900, and the like.

The CPU 901 controls an input device 910 such as a mouse and a keyboard and an output device 911 such as a display via the input/output I/F 905. The CPU 901 acquires data from the input device 910 and outputs generated data to the output device 911 via the input/output I/F 905. Note that a GPU (Graphics Processing Unit) or the like may be used as the processor together with the CPU 901.

The HDD 904 stores programs executed by the CPU 901, data used by the programs, and the like. The communication I/F 906 receives data from another device via a communication network (for example, an NW (Network) 920) and outputs the data to the CPU 901, and transmits the information to the other device via the communication network.

The media I/F 907 reads a program or data stored in a recording medium 912 and outputs the data to the CPU 901 via the RAM 903. The CPU 901 loads the program from the recording medium 912 on the RAM 903 via the media I/F 907 and executes the loaded program. The recording medium 912 is an optical recording medium such as a DVD (Digital Versatile Disk), a PD (Phase change rewritable Disk), a magneto optical recording medium such as a MO (Magneto Optical disk), a magnetic recording medium, a conductor memory tape medium, a semiconductor memory, or the like.

For example, when the computer 900 serves as the network control system 100 according to the present embodiment, the CPU 901 of the computer 900 realizes the functions of the network control system 100 by executing the program loaded on the RAM 903. And data in the RAM 903 are stored in the HDD 904. The CPU 901 reads the program from the recording medium 912 and executes the program. In addition, the CPU 901 may read a program related to the target processing from another device via the communication network (NW 920).

### [Effect]

The effects of the network control system and the like according to the present invention will be described below. A network control system 100 according to the present invention is a network control system for changing a route set in a network (a measurement target network 10 in FIG. 1), the network control system 100 including: an NW state measurement unit 111 (FIG. 1 reference) for measuring a network topology, a delay amount of each link, a traffic amount, and a link band, and holding it as NW state information in an NW state holding unit (an NW state holding DB 112 in FIG. 1); an NW design information holding unit (an NW design information holding DB 132 in FIG. 1) for holding a quality requirement (delay quality requirement) including an endpoint and a delay amount, and information on a necessary band, as a design information of each NW; a route calculation unit 121 (FIG. 1 reference) for calculating an optimum route on the basis of the NW state information held in the NW state holding unit and the NW design information held in the NW design information holding part, with quality requirements as a constraint condition; and a route control unit 131 (FIG. 1 reference) for performing route control on the basis of route calculated by the route calculation unit 121.

Thus, the present invention can achieve route control in accordance with the NW state by optimizing the route in consideration of delay measurement information in the NW and request quality information such as a flow of a route control object and a VPN in addition to a conventional traffic amount, and can achieve both of the request quality and optimization of NW resource utilization efficiency.

The network control system 100 of the present embodiment receives the delay amount for each link in the NW and the endpoint/request quality for each VPN, and performs route control based on a route calculation algorithm (route calculation method) for optimizing the utilization efficiency of NW resources while satisfying the requirements of the delay quality in units of VPN, and a calculation result.

In the network control system 100, the NW state measurement unit 111 performs time stamp processing by hardware when transmitting and receiving the probe packet, and measures a delay amount of each link from a difference of time stamps when transmitting and receiving the probe packet.

Thus, the return processing, time stamp processing, and time synchronization between devices of the probe packet in the NW are not required, and highly accurate measurement of delay and jitter can be executed in real time.

In the network control system 100, the route calculation unit 121 uses an objective function for evaluating the optimization degree of the calculation result, and applies the objective function to calculate the route.

In this way, by using the objective function (for example, an objective function for minimizing the maximum link use rate in the NW) for evaluating the optimization degree of the calculation result, the calculation time of the route calculation can be shortened, and the optimum route control can be performed in a state where the quality requirements are satisfied.

In the network control system 100, a route calculation unit 121 calculates a route by using the delay amount of each link as a link cost between endpoints of the NW design information, and calculates a route in which the total of the link costs satisfies the quality requirement.

Thus, the route in which the total of link costs satisfies the quality requirement is selected, and the route control in a state in which the quality requirement is satisfied becomes possible. When the total link cost does not satisfy the quality requirement, the link can be excluded from the route calculation, and the calculation time of the route calculation can be shortened.

In the network control system 100, a route calculation unit 121 calculates a route by using the delay amount of each link as a link cost between endpoints of the NW design information, and calculates a route for minimizing the total of the link costs.

Thus, by selecting the route with the minimum total link cost, the optimum route control can be performed in a state of satisfying the quality requirements.

In the network control system 100, a route calculation unit 121 calculates route candidates satisfying quality requirements for the NW, and selects the route having the smallest difference between the route information and the present route information as the optimum route.

Thus, the route change scale can be reduced while reducing the maximum link use rate by selecting the route having the smallest difference from the present route information as the optimum route.

### [Others]

Also, of the various processing described in the present embodiment, all or part of the processing described as being performed automatically can be entirely or partially performed manually, or, alternatively, the processing described as being performed manually can also be entirely or partially performed automatically by a known method. Furthermore, information including processing procedures, control procedures, specific names, and various types of data and parameters set forth in the description and drawings given above can be arbitrarily changed unless otherwise specified.

In addition, the elements of the devices shown are ideational functions and may not be necessarily configured as physically shown. In other words, the specific aspects of distribution and integration of the devices are not limited to those illustrated in the drawings, all or part of the components may be distributed or integrated functionally or physically in desired units depending on various kinds of loads and states of use.

Further, the respective configurations, functions, processing parts, processing means and the like are provided with a plurality of processing parts, a part or all of them may be realized by hardware, for example, by designing it by an integrated circuit. Further, the above-mentioned structures, functions, etc. may be realized by software for interpreting and executing programs for realizing the respective functions by the processor. Information such as a program, a table, a file and the like for realizing each function is stored in a memory, a hard disk, a recording apparatus such as an SSD (Solid State Drive), or a recording medium such as an IC (Integrated Circuit), an SD (Secure Digital) card, an optical disk, or the like. In addition, in the present specification, the processing step for describing the time-series processing is performed not only in the time-series manner along the described order but also in the case where the processing is not necessarily performed in the time-series manner, the processing includes processing executed in parallel or individually (for example, parallel processing or processing by an object).

### REFERENCE SIGNS LIST

10 Measurement target network (Communication network)
60, 70 Route information
61 to 63 VPN information (NW design information)
100 Network control system
110 NW state measurement device
111 NW state measurement unit
112 NW state holding DB (NW state holding unit)
120 Route calculation device
121 Route calculation unit
130 Route control device
131 Route control unit
132 NW design information holding DB (NW design information holding unit)
200 Delay measurement system

1. A network control system for changing a route set in a network (NW), comprising:
a processor; and
a memory device storing instructions that, when executed by the processor, configure the processor to:
measure an NW topology, a delay amount of each link, a traffic amount, and a link band, and hold a NW state as NW state information,
hold information on quality requirements including an endpoint, a delay amount, and a required band, as design information of each NW,
perform an optimum route calculation on a basis of the NW state information and NW design information, and
perform route control on a basis of the calculated route.

2. The network control system according to claim 1, wherein: the processor is configured to perform time stamp processing by hardware when transmitting/receiving a probe packet, and measure the delay amount of each link from a difference of time stamps when transmitting/receiving.

3. The network control system according to claim 1, wherein: the processor is configured to use an objective function for evaluating a optimization degree of a calculation result, and apply the objective function to calculate a route.

4. The network control system according to claim 1, wherein: the processor is configured to calculate a route with the delay amount of each link as a link cost between endpoints of the NW design information, and calculate a route in which a total of the link costs satisfies the quality requirements.

5. The network control system according to claim 1, wherein: the processor is configured to calculate a route with the delay amount of each link as a link cost between endpoints of the NW design information, and calculate a route in which a total of the link costs becomes minimum.

6. The network control system according to claim 1, wherein: the processor is configured to calculate route candidates satisfying the quality requirements for the NW, and select one of the calculated route candidates having the smallest difference from the current route information as an optimum route.

7. A route calculation method for a network control system that changes a route set in a network (NW), comprising:
measuring an NW topology, a delay amount of each link, a jitter, a traffic amount, and a link band, and holding the measured NW topology, the measured delay amount of each link, the measured jitter, the measured traffic amount, and the measured link band in an NW state holding database (DB) as NW state information;
holding information on quality requirements including an endpoint, a delay amount, and a required band in an NW design information holding DB as design information of each NW;
performing an optimum route calculation on a basis of the NW state information held in the NW state holding DB and NW design information held in the NW design information holding DB, using the quality requirements as constraints;
performing a route control on a basis of the calculated route.

8. A non-transitory computer readable medium storing a program, wherein executing of the program causes a computer to perform the route calculation method according to claim 7.

9. A non-transitory computer readable medium storing a program, wherein executing of the program causes a computer to operate as the network control system according to claim 1.

10. A non-transitory computer readable medium storing a program, wherein executing of the program causes a computer to operate as the network control system according to claim 2.

11. A non-transitory computer readable medium storing a program, wherein executing of the program causes a computer to operate as the network control system according to claim 3.

12. A non-transitory computer readable medium storing a program, wherein executing of the program causes a computer to operate as the network control system according to claim 4.

13. A non-transitory computer readable medium storing a program, wherein executing of the program causes a computer to operate as the network control system according to claim 5.

14. A non-transitory computer readable medium storing a program, wherein executing of the program causes a computer to operate as the network control system according to claim 6.
